(19) United States
(12) Patent Application Publication
(10) Pub. No.: US 2022/0085650 A1
(43) Pub. Date: Mar. 17, 2022

(54) NON-CONTACT POWER SUPPLY DEVICE

(71) Applicant: OMRON Corporation, Kyoto-shi, KYOTO (JP)

(72) Inventors: Atsushi NOMURA, Kyoto-shi (JP); Goro NAKAO, Kyoto-shi (JP); Yusuke KAWAI, Kyoto-shi (JP); Masanobu NAKAJO, Kyoto-shi (JP); Takahiro TAKEYAMA, Kyoto-shi (JP); Kenichi TABATA, Kyoto-shi (JP)

(73) Assignee: OMRON Corporation, Kyoto-shi, KYOTO (JP)

(21) Appl. No.: 17/416,546

(22) PCT Filed: Dec. 3, 2019
(86) PCT No.: PCT/JP2019/047251

§ 371 Date: Jun. 21, 2021

(30) Foreign Application Priority Data
Jan. 18, 2019 (JP) 2019-007216

(51) Int. Cl. H02J 50/12; H04B 5/00; H02J 50/00

(52) U.S. Cl. CPC H02J 50/12; H02J 50/005; H04B 5/0037

(57) ABSTRACT

A measured value of an output voltage may be obtained by rectifying power received through a resonance circuit including a reception coil that receives power from a transmission coil of a power transmission device and a resonance capacitor connected in series with the reception coil. When the measured value becomes equal to or larger than an upper limit threshold value, a power reception device of a non-contact power supply device short-circuits a resonance suppression coil provided so as to be electromagnetically couplable with the reception coil. The power transmission device and the power reception device are provided such that power is transmitted from the transmission coil to the reception coil, and the reception coil and the resonance suppression coil are provided such that a coupling degree between the resonance suppression coil and the transmission coil becomes higher than a coupling degree between the reception coil and the transmission coil.

### TECHNICAL FIELD

The invention relates to a non-contact power supply device.

### BACKGROUND ART

Conventionally, there has been studied a so-called non-contact power feeding (also referred to as wireless power feeding) technique that transmits power through a space without a metal contact or the like interposed therebetween.

In a power supply device using a non-contact power feeding technique (hereinafter, simply referred to as a non-contact power supply device), a primary-side (transmission-side) coil (hereinafter, referred to as a transmission coil) and a secondary-side (reception-side) coil (hereinafter, referred to as a reception coil) are electromagnetically coupled, and thus power is transmitted from a transmission-side device to a reception-side device via the transmission coil and the reception coil.

In such a non-contact power feeding technique, it has been proposed that the reception-side device is provided with a coil separate from the reception coil, and thus an excessive increase in an output voltage is suppressed or a larger current is obtained as a secondary current (see, for example, Patent Documents 1 and 2).

For example, when a positional relationship between the transmission coil and the reception coil changes, a coupling degree between the transmission coil and the reception coil changes. As a result, the output voltage from the reception-side device to a load circuit also changes. In some cases, the output voltage to the load circuit may be excessively increased to cause a failure in the reception-side device, the load circuit, or the like. Therefore, Patent Document 1 proposes that a resonance suppression circuit including a control coil magnetically coupled to a power reception resonance coil is provided on a reception side, the output voltage is monitored, and a resonance operation is suppressed by a method of short-circuiting and opening the control coil by a switch.

Further, in order to increase the secondary current obtained on the reception side, Patent Document 2 proposes a non-contact power supply device including a power receiver that has a secondary coil and a tertiary coil magnetically coupled to a primary coil of a power feeder, and generates power to be supplied to a load to the secondary coil, the tertiary coil being connected to a capacitor for resonance. In this non-contact power supply device, it has been proposed that the secondary coil and the tertiary coil are separately provided, and the tertiary coil is provided on a front side closer to the primary coil than the secondary coil.

### PRIOR ART DOCUMENT

### Patent Documents

Patent Document 1: Japanese Unexamined Patent Publication No. 2015-65724

Patent Document 2: Japanese Unexamined Patent Publication No. 2010-273441

### SUMMARY OF THE INVENTION

### Problems to be Solved by the Invention

However, in the technique disclosed in Patent Document 1, in a case where there is no load circuit connected to the reception coil or a current flowing through the load circuit is significantly small, a resonance operation of a power reception resonance circuit including the power reception resonance coil cannot be sufficiently suppressed, and as a result, an excessive rise in the voltage output from the power reception resonance circuit may not be suppressed. Further, in the technique disclosed in Patent Document 2, even in a case where a coupling degree between the primary coil and the tertiary coil connected to the capacitor for resonance becomes significantly high, it is not assumed that the resonance operation of the circuit including the tertiary coil is suppressed.

Therefore, an object of the invention is to provide a non-contact power supply device capable of suppressing an excessive increase in an output voltage from a power reception-side device.

### Means for Solving the Problem

As one aspect of the invention, there is provided a non-contact power supply device including a power transmission device and a power reception device in which power is transmitted from the power transmission device in a non-contact manner. In this non-contact power supply device, the power transmission device has a transmission coil configured to transmit power to the power reception device, and a power supply circuit configured to supply AC power to the transmission coil. Further, the power reception device includes a resonance circuit including a reception coil configured to receive power from the power transmission device and a resonance capacitor connected in series with the reception coil, a rectifier circuit configured to rectify power received via the resonance circuit, a resonance suppression coil provided to be electromagnetically couplable with the reception coil, a switch circuit connected to the resonance suppression coil and configured to switch between short-circuiting and opening of the resonance suppression coil, a voltage detection circuit configured to measure an output voltage of power outputted from the rectifier circuit and obtain a measured value of the output voltage, and a determination circuit configured to control the switch circuit to short-circuit the resonance suppression coil when the measured value of the output voltage becomes equal to or larger than a predetermined upper limit threshold value. In a case where the power transmission device and the power reception device are provided such that power is transmitted from the transmission coil to the reception coil, the reception coil and the resonance suppression coil are provided such that a coupling degree between the resonance suppression coil and the transmission coil is higher than a coupling degree between the reception coil and the transmission coil.

The non-contact power supply device of the invention having such a configuration can suppress an excessive increase in the output voltage from the power reception device. In particular, even in a case where there is no load circuit connected to the resonance circuit of the power reception device or a current flowing through the load circuit is significantly small, an excessive rise in the output voltage can be suppressed.

In this non-contact power supply device, in a case where the power transmission device and the power reception device are provided such that power is transmitted from the transmission coil to the reception coil, the reception coil and the resonance suppression coil are preferably provided such that the resonance suppression coil is closer to the transmission coil than the reception coil.

As a result, in a case where the power transmission device and the power reception device are provided such that power is transmitted from the transmission coil to the reception coil, the coupling degree between the resonance suppression coil and the transmission coil can be made higher than the coupling degree between the reception coil and the transmission coil more reliably. Therefore, the non-contact power supply device can more reliably suppress an excessive rise in the output voltage from a reception-side device.

In this case, in a case where the power transmission device and the power reception device are provided such that power is transmitted from the transmission coil to the reception coil, the reception coil and the resonance suppression coil are preferably provided such that the resonance suppression coil is located between the transmission coil and the reception coil.

Thus, even when a positional relationship between the power transmission device and the power reception device changes during power transmission or each time of power transmission, the non-contact power supply device can maintain the coupling degree between the resonance suppression coil and the transmission coil to be higher than the coupling degree between the reception coil and the transmission coil, and then an excessive increase in the output voltage from the power reception-side device can be more reliably suppressed.

### BRIEF DESCRIPTION OF THE DRAWINGS

FIG. 1 is a schematic configuration diagram of a non-contact power supply device according to one embodiment of the invention.

FIG. 2A is a diagram illustrating an example of a switch circuit.

FIG. 2B is a diagram illustrating another example of the switch circuit.

FIG. 2C is a diagram illustrating still another example of the switch circuit.

FIG. 2D is a diagram illustrating still another example of the switch circuit.

FIG. 3A is a schematic sectional view in a plane passing through central axes of a transmission coil, a reception coil, and a resonance suppression coil.

FIG. 3B is a schematic plan view of an example of arrangement of the reception coil and the resonance suppression coil as viewed from the transmission coil.

FIG. 4A is a schematic sectional view in a plane passing through central axes of a reception coil and a resonance suppression coil according to a modification.

FIG. 4B is a schematic sectional view in a plane passing through central axes of a reception coil and a resonance suppression coil according to another modification.

FIG. 4C is a schematic sectional view in a plane passing through central axes of a reception coil and a resonance suppression coil according to still another modification.

FIG. 4D is a schematic plan view of another example of arrangement of the reception coil and the resonance suppression coil as viewed from the transmission coil according to still another modification.

FIG. 5A is a schematic sectional view in a plane passing through central axes of the transmission coil, the reception coil, and the resonance suppression coil according to the embodiment.

FIG. 5B is a schematic sectional view in a plane passing through central axes of a transmission coil, a reception coil, and a resonance suppression coil according to a comparative example.

FIG. 5C is a schematic sectional view in a plane passing through central axes of a transmission coil, a reception coil, and a resonance suppression coil according to a comparative example.

FIG. 6 is a diagram illustrating an example of a simulation result of frequency characteristics of an output voltage in a case where a current flowing through a load circuit connected to a power reception device is small.

FIG. 7 is a diagram illustrating an example of a simulation result of frequency characteristics of an output voltage in a case where there is a load connected to the power reception device.

FIG. 8A is a schematic sectional view illustrating a positional relationship between a reception coil and a resonance suppression coil in a plane passing through central axes of the reception coil and the resonance suppression coil according to a modification.

FIG. 8B is a schematic sectional view illustrating a positional relationship between a reception coil and a resonance suppression coil in a plane passing through center axes of the reception coil and the resonance suppression coil according to a modification.

### MODE FOR CARRYING OUT THE INVENTION

Hereinafter, a non-contact power supply device according to one embodiment of the invention is described with reference to the drawings. In this non-contact power supply device, a power reception-side device has a reception coil for power reception and a coil for resonance suppression (hereinafter, simply referred to as a resonance suppression coil) provided so as to be electromagnetically couplable with the reception coil. When an output voltage from a resonance circuit including the reception coil becomes equal to or larger than a predetermined threshold value, the power reception-side device short-circuits the resonance suppression coil to change a resonance condition of the resonance circuit. Further, in the non-contact power supply device, in a case where a transmission-side device and the reception-side device are provided such that power can be transmitted between the transmission-side device and the reception-side device, that is, in a case where the transmission-side device and the reception-side device are provided such that a transmission coil and the reception coil are electromagnetically coupled, the resonance suppression coil and the reception coil are provided such that a coupling degree between the transmission coil and the resonance suppression coil is higher than a coupling degree between the transmission coil and the reception coil. As a result, the non-contact power supply device suppresses an excessive increase in the output voltage from the resonance circuit including the reception coil even in a case where there is no load circuit connected to the power reception-side device or a current flowing through the load circuit is significantly small (for example, in a case where the load circuit is a secondary battery and the secondary battery is almost fully charged, and the like).

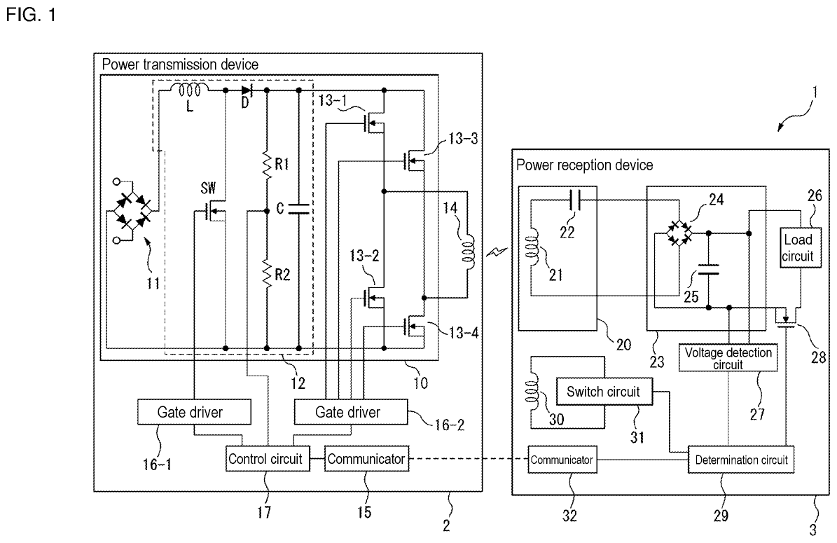

FIG. 1 is a schematic configuration diagram of the non-contact power supply device according to one embodiment of the invention. As illustrated in FIG. 1, a non-contact power supply device 1 includes a power transmission device 2 and a power reception device 3 that transmits power from the power transmission device 2 via a space in a non-contact manner. The power transmission device 2 includes a power supply circuit 10, a transmission coil 14, a communicator 15, gate drivers 16-1 and 16-2, and a control circuit 17. Meanwhile, the power reception device 3 has a resonance circuit 20 including a reception coil 21 and a resonance capacitor 22, a rectifying and smoothing circuit 23, a load circuit 26, a voltage detection circuit 27, a switching element 28, a determination circuit 29, a resonance suppression coil 30, a switch circuit 31, and a communicator 32. The non-contact power supply device 1 does not use resonance on the transmission side, but has a configuration similar to a configuration of a so-called primary series secondary series capacitor system (hereinafter, referred to as an SS system), and thus can perform a constant voltage output operation.

First, the power transmission device 2 will be described.

The power supply circuit 10 supplies AC power having an adjustable switching frequency and an adjustable voltage to the transmission coil 14. For this purpose, the power supply circuit 10 has a power source 11, a power factor correction circuit 12, and four switching elements 13-1 to 13-4.

The power source 11 supplies power having a predetermined pulsating voltage. For this purpose, the power source 11 is connected to a commercial AC power source and has a full-wave rectifier circuit for rectifying the AC power supplied from the AC power source.

The power factor correction circuit 12 converts a voltage of the power outputted from the power source 11 into a voltage in accordance with control from the control circuit 17 and outputs the voltage. Thus, the power factor correction circuit 12 has, for example, a coil L and a diode D that are connected in series sequentially from a positive electrode-side terminal of the power source 11, a switching element SW that is an n-channel MOSFET having a drain terminal connected between the coil L and the diode D and a source terminal connected to a negative electrode-side terminal of the power source 11, and a smoothing capacitor C that is connected in parallel with the switching element SW with the diode D interposed therebetween. A gate terminal of the switching element SW is connected to the gate driver 16-1. Further, the power factor correction circuit 12 has two resistors R1 and R2 connected in series between the positive electrode-side terminal and the negative electrode-side terminal of the power source 11. The resistors R1 and R2 are connected between the diode D and the smoothing capacitor C in parallel with the smoothing capacitor C. Then, a voltage between the resistor R1 and the resistor R2 is measured by the control circuit 17 as a representative of a voltage outputted from the diode D.

In accordance with a duty ratio instructed by the control circuit 17, the gate driver 16-1 controls turning on and off of the switching element SW such that a track of a current waveform outputted from the diode D coincides with a track of the voltage supplied from the power source 11, and thus the power factor correction circuit 12 performs a power factor correction operation. As the duty ratio at which the switching element SW is turned on increases, the voltage outputted from the diode D increases.

The voltage outputted from the diode D is smoothed by the smoothing capacitor C and supplied to the transmission coil 14 via the four switching elements 13-1 to 13-4.

Note that the power factor correction circuit 12 is not limited to the above configuration, and may have another configuration in which the output voltage can be adjusted by control from the control circuit 17.

The four switching elements 13-1 to 13-4 constitute a full-bridge inverter circuit. Thus, the switching elements 13-1 to 13-4 can be n-channel MOSFETs, for example. Then, among the four switching elements 13-1 to 13-4, the switching element 13-1 and the switching element 13-2 are connected in series between the positive electrode-side terminal and the negative electrode-side terminal of the power source 11 via the power factor correction circuit 12. In the embodiment, the switching element 13-1 is connected to a positive electrode side of the power source 11, and the switching element 13-2 is connected to a negative electrode side of the power source 11. A drain terminal of the switching element 13-1 is connected to the positive electrode-side terminal of the power source 11 via the power factor correction circuit 12, and a source terminal of the switching element 13-1 is connected to a drain terminal of the switching element 13-2. A source terminal of the switching element 13-2 is connected to the negative electrode-side terminal of the power source 11 via the power factor correction circuit 12. Further, the source terminal of the switching element 13-1 and the drain terminal of the switching element 13-2 are connected to one end of the transmission coil 14, and the source terminal of the switching element 13-2 is connected to the other end of the transmission coil 14 via the switching element 13-4.

Similarly, among the four switching elements 13-1 to 13-4, the switching element 13-3 and the switching element 13-4 are connected in parallel with the switching element 13-1 and the switching element 13-2 and in series between the positive electrode-side terminal and the negative electrode-side terminal of the power source 11 via the power factor correction circuit 12. Further, the switching element 13-3 is connected to the positive electrode side of the power source 11, and the switching element 13-4 is connected to the negative electrode side of the power source 11. A drain terminal of the switching element 13-3 is connected to the positive electrode-side terminal of the power source 11 via the power factor correction circuit 12, and a source terminal of the switching element 13-3 is connected to a drain terminal of the switching element 13-4. A source terminal of the switching element 13-4 is connected to the negative electrode-side terminal of the power source 11 via the power factor correction circuit 12. Further, the source terminal of the switching element 13-3 and the drain terminal of the switching element 13-4 are connected to the other end of the transmission coil 14.

The gate terminals of the switching elements 13-1 to 13-4 are connected to the control circuit 17 via the gate driver 16-2. Furthermore, the gate terminals of the switching elements 13-1 to 13-4 may be each connected to the source terminal of the own switching element via a resistor in order to ensure that the switching element is turned on when a voltage to turn on the switching element is applied. The switching elements 13-1 to 13-4 are turned on and off at an adjustable switching frequency in accordance with a control signal from the control circuit 17. In the embodiment, a pair of the switching element 13-1 and the switching element 13-4 and a pair of the switching element 13-2 and the switching element 13-3 are alternately switched on and off. That is, while the switching element 13-1 and the switching element 13-4 are turned on, the switching element 13-2 and the switching element 13-3 are turned off. Conversely, while the switching element 13-2 and the switching element 13-3 are turned on, the switching element 13-1 and the switching element 13-4 are turned off. As a result, the DC power supplied from the power source 11 via the power factor correction circuit 12 is converted into AC power having the switching frequency of each switching element and supplied to the transmission coil 14.

Then, the transmission coil 14 transmits the AC power supplied from the power supply circuit 10 to the resonance circuit 20 of the power reception device 3 via the space.

Each time the communicator 15 receives a wireless signal from the communicator 32 of the power reception device 3, the communicator 15 extracts, from the wireless signal, abnormal voltage generation information indicating that the output voltage from the rectifying and smoothing circuit 23 of the power reception device 3 has excessively increased, or determination information indicating whether the non-contact power supply device 1 is performing the constant voltage output operation, and outputs the information to the control circuit 17. For this purpose, the communicator 15 has, for example, an antenna that receives a wireless signal in accordance with a predetermined wireless communication standard, and a communication circuit that demodulates the wireless signal. Note that the predetermined wireless communication standard can be, for example, ISO/IEC 15693, Zig Bee (registered trademark), or Bluetooth (registered trademark).

The gate driver 16-1 receives a control signal for switching on and off the switching element SW of the power factor correction circuit 12 from the control circuit 17, and changes the voltage applied to the gate terminal of the switching element SW in accordance with the control signal. That is, upon receipt of the control signal for turning on the switching element SW, the gate driver 16-1 applies a relatively high voltage for turning on the switching element SW to the gate terminal of the switching element SW. On the other hand, upon receipt of the control signal for turning off the switching element SW, the gate driver 16-1 applies a relatively low voltage for turning off the switching element SW to the gate terminal of the switching element SW. As a result, the gate driver 16-1 switches on and off the switching element SW of the power factor correction circuit 12 at a timing instructed by the control circuit 17.

The gate driver 16-2 receives a control signal for switching on and off the switching elements 13-1 to 13-4 from the control circuit 17, and changes the voltage applied to the gate terminal of the switching elements 13-1 to 13-4 in accordance with the control signal. That is, upon receipt of the control signal for turning on the switching element 13-1 and the switching element 13-4, the gate driver 16-2 applies a relatively high voltage for turning on the switching element 13-1 and the switching element 13-4 to the gate terminal of the switching element 13-1 and the gate terminal of the switching element 13-4. As a result, the current from the power source 11 flows through the switching element 13-1, the transmission coil 14, and the switching element 13-4. On the other hand, upon receipt of the control signal for turning off the switching element 13-1 and the switching element 13-4, the gate driver 16-2 applies a relatively low voltage for turning off the switching element 13-1 and the switching element 13-4 to the gate terminal of the switching element 13-1 and the gate terminal of the switching element 13-4. As a result, the current from the power source 11 does not flow through the switching element 13-1 and the switching element 13-4. The gate driver 16-2 similarly controls the voltage applied to the gate terminals of the switching element 13-2 and the switching element 13-3. Therefore, when the switching element 13-1 and the switching element 13-4 are turned off and the switching element 13-2 and the switching element 13-3 are turned on, the current from the power source 11 flows through the switching element 13-3, the transmission coil 14, and the switching element 13-2.

The control circuit 17 has, for example, a nonvolatile memory circuit and a volatile memory circuit, an arithmetic circuit, and an interface circuit for connection to another circuit. Upon receipt of abnormal voltage generation information from the communicator 15, the control circuit 17 starts controlling the switching frequency and the voltage of the AC power supplied from the power supply circuit 10 to the transmission coil 14. After that, every time the control circuit 17 receives determination information from the communicator 15, the control circuit controls the switching frequency and the voltage of the AC power supplied from the power supply circuit 10 to the transmission coil 14 in accordance with the determination information.

Therefore, the control circuit 17 controls the switching elements 13-1 to 13-4 in the embodiment. Specifically, the control circuit 17 alternately turns on a pair of the switching element 13-1 and the switching element 13-4 and a pair of the switching element 13-2 and the switching element 13-3. Further, the control circuit 17 equalizes a period in which the pair of the switching element 13-1 and the switching element 13-4 is turned on and a period in which the pair of the switching element 13-2 and the switching element 13-3 is turned on within one cycle corresponding to the switching frequency. It is preferable that the control circuit 17 prevents the pair of the switching element 13-1 and the switching element 13-4 and the pair of the switching element 13-2 and the switching element 13-3 from being simultaneously turned on and short-circuiting the power source 11. Therefore, when the control circuit 17 switches on and off the pair of the switching element 13-1 and the switching element 13-4 and the pair of the switching element 13-2 and the switching element 13-3, a dead time in which both pairs of the switching elements are turned off may be provided.

Further, the control circuit 17 selects the duty ratio according to the switching frequency with reference to a reference table representing a relationship between the switching frequency and the duty ratio of on-off control of the switching element SW of the power factor correction circuit 12 corresponding to the voltage applied to the transmission coil 14, the voltage being a constant voltage output at the switching frequency. Then, the control circuit 17 determines a timing at which the switching element SW is switched on and off in accordance with the duty ratio and the change in the output voltage from the diode D of the power factor correction circuit 12, and outputs a control signal indicating the timing to the gate driver 16-1.

Furthermore, in a case where the communicator 15 cannot receive the wireless signal from the power reception device 3, it is assumed that the power reception device 3 is not at such a position as to be able to receive power supply from the power transmission device 2, that is, the power transmission device 2 is in a standby state. Therefore, in this case, the control circuit 17 may set the duty ratio of the on-off control of the switching element SW to a settable minimum value. As a result, while the power transmission device 2 is in the standby state, the voltage applied to the transmission coil 14 also has a settable minimum value, and thus an energy loss is suppressed.

Note that details of control of the switching frequency and the voltage applied to the transmission coil 14 by the control circuit 17 will be described later.

Next, the power reception device 3 will be described.

The resonance circuit 20 is an LC resonance circuit including the reception coil 21 and the resonance capacitor 22 connected in series with each other. One end of the reception coil 21 included in the resonance circuit 20 is connected to one input terminal of the rectifying and smoothing circuit 23 via the resonance capacitor 22. The other end of the reception coil 21 is connected to the other input terminal of the rectifying and smoothing circuit 23.

The reception coil 21 receives power from the transmission coil 14 by resonating with an alternating current flowing through the transmission coil 14 of the power transmission device 2 together with the resonance capacitor 22. Then, the reception coil 21 outputs the received power to the rectifying and smoothing circuit 23 via the resonance capacitor 22. Note that the number of windings of the reception coil 21 and the number of windings of the transmission coil 14 of the power transmission device 2 may be the same or different.

The resonance capacitor 22 is connected in series with the reception coil 21. That is, the resonance capacitor 22 has one end connected to one end of the reception coil 21 and the other end connected to the rectifying and smoothing circuit 23. The resonance capacitor 22 resonates with the reception coil 21 to output the received power to the rectifying and smoothing circuit 23.

The rectifying and smoothing circuit 23 is an example of a rectifier circuit, has a full-wave rectifier circuit 24 having four bridge-connected diodes and a smoothing capacitor 25, rectifies and smooths power received by the resonance circuit 20 and received from the resonance circuit 20, and converts the power into DC power. The rectifying and smoothing circuit 23 outputs the DC power to the load circuit 26.

The voltage detection circuit 27 measures an output voltage between both terminals of the rectifying and smoothing circuit 23 at a predetermined cycle. The output voltage between both terminals of the rectifying and smoothing circuit 23 corresponds to the output voltage of the resonance circuit 20 on a one-to-one basis, and thus the measured value of the output voltage between both terminals of the rectifying and smoothing circuit 23 is indirectly the measured value of the output voltage of the resonance circuit 20. The voltage detection circuit 27 can be, for example, any of various known voltage detection circuits capable of detecting a DC voltage. Then, the voltage detection circuit 27 outputs a voltage detection signal indicating the measured value of the output voltage to the determination circuit 29.

The switching element 28 is, for example, a MOSFET, and is connected between the rectifying and smoothing circuit 23 and the load circuit 26. When the switching element 28 is turned off, a current does not flow from the rectifying and smoothing circuit 23 to the load circuit 26, and when the switching element 28 is turned on, a current flows from the rectifying and smoothing circuit 23 to the load circuit 26.

The determination circuit 29 determines whether the measured value of the output voltage received from the voltage detection circuit 27 is equal to or larger than a predetermined upper limit threshold value. When the measured value is equal to or larger than the upper limit threshold value, the switch circuit 31 is controlled to short-circuit the resonance suppression coil 30, and the communicator 32 is notified that the measured value of the output voltage is equal to or larger than the upper limit threshold value, that is, the output voltage is excessively increased. Thus, the determination circuit 29 can change a resonance frequency of the resonance circuit 20 immediately after the measured value of the output voltage reaches the upper limit threshold value to decrease the power transmitted between the power transmission device 2 and the power reception device 3, and as a result, the output voltage from the resonance circuit 20 can be decreased. The upper limit threshold value can be an upper limit value of the voltage at which the load circuit 26 and the power reception device 3 do not fail or a value obtained by subtracting a predetermined offset value from the upper limit value.

Further, while the switching frequency and the voltage of the AC power applied to the transmission coil 14 are controlled, the determination circuit 29 determines whether the measured value of the output voltage is included within an allowable range of the voltage when the constant voltage output operation is performed. Then, the determination circuit 29 notifies the communicator 32 of a determination result. The upper limit of the allowable range of the voltage is preferably set to be equal to or less than the upper limit threshold value.

For this purpose, the determination circuit 29 has, for example, a memory circuit that stores the allowable range of the voltage, an arithmetic circuit that compares the measured value of the output voltage with each of the upper limit threshold value and the allowable range of the voltage, and a control circuit that controls turning on and off of the switching element 28 and the switch circuit 31. Note that the determination circuit 29 may have a circuit similar to the circuit used for controlling turning on and off of the control coil disclosed in Patent Document 1 as a circuit for comparing the measured value of the output voltage with the upper limit threshold value and switching on and off the switch circuit 31 in accordance with the result. In this case, the voltage for turning off the switch circuit 31 may be set lower than the voltage for turning on the switch circuit 31.

Furthermore, the determination circuit 29 switches on and off the switching element 28 at a predetermined cycle while the measured value of the output voltage is out of the allowable range of the voltage. Thus, the resistance value of the entire circuit including the load circuit 26 connected to the rectifying and smoothing circuit 23 changes at the predetermined cycle. Thus, the determination circuit 29 can determine whether the non-contact power supply device 1 is performing the constant voltage output operation by determining whether the measured value of the output voltage becomes substantially constant while switching on and off the switching element 28. Then, while the measured value of the output voltage is substantially constant even if the switching element 28 is switched on and off at the predetermined cycle, the determination circuit 29 notifies the communicator 32 that the non-contact power supply device 1 is performing the constant voltage output operation.

In a case where the non-contact power supply device 1 performs the constant voltage output operation for a certain period in which the measured value of the output voltage is longer than the predetermined cycle, the determination circuit 29 stops switching on and off the switching element 28 and maintains a state of turning on. Then, the determination circuit 29 determines whether the measured value of the output voltage is included in the allowable range of the voltage, and notifies the communicator 32 of the determination result.

At this time, when the measured value of the output voltage is included in the allowable range of the voltage for a certain period longer than the predetermined cycle, the determination circuit 29 notifies the communicator 32 of the determination result indicating that the non-contact power supply device 1 is performing the constant voltage output operation and the measured value of the output voltage is within the allowable range of the voltage.

In a modification, the determination circuit 29 may have a resistor connected to the rectifying and smoothing circuit 23 in parallel with the load circuit 26. In this case, the switching element 28 may be provided in series with the resistor and in parallel with the load circuit 26. In this case, while the measured value of the output voltage is included in the allowable range of the voltage, the determination circuit 29 turns off the switching element 28. On the other hand, when the measured value of the output voltage deviates from the allowable range of the voltage, the determination circuit 29 may switch on and off the switching element 28 at a predetermined cycle as in the embodiment. In this modification, even when the non-contact power supply device 1 is not performing the constant voltage output operation, power supply to the load circuit 26 is continued.

In another modification, a second switching element such as a MOSFET may be provided in parallel with the resistor and in series with the load circuit 26. In this case, while the measured value of the output voltage is included in the allowable range of the voltage, the determination circuit 29 turns on the second switching element to enable power supply to the load circuit 26. On the other hand, when the measured value of the output voltage deviates from the allowable range of the voltage, the determination circuit 29 may turn off the second switching element and stop the power supply to the load circuit 26. As a result, even if the voltage of the received power becomes excessively high while the switching frequency is adjusted in the power transmission device 2, the excessively high voltage is prevented from being applied to the load circuit 26.

The resonance suppression coil 30 is provided so as to be electromagnetically couplable with the reception coil 21 of the resonance circuit 20. For example, the resonance suppression coil 30 and the reception coil 21 are wound around the same magnetic core. Both ends of the resonance suppression coil 30 are connected to the switch circuit 31. When the resonance suppression coil 30 is short-circuited by the switch circuit 31, the resonance suppression coil 30 is electromagnetically coupled to the reception coil 21, and the resonance frequency of the resonance circuit 20 changes. Therefore, even if the output voltage from the resonance circuit 20 excessively increases, the power transmitted from the power transmission device 2 to the power reception device 3 decreases due to the short circuit of the resonance suppression coil 30, and thus the output voltage from the resonance circuit 20 also decreases. The number of windings of the reception coil 21 and the number of windings of the resonance suppression coil 30 may be equal to each other or different from each other. Further, the number of windings of the transmission coil 14 and the number of windings of the resonance suppression coil 30 may be equal to each other or may be different from each other.

On the other hand, when the switch circuit 31 opens both the ends of the resonance suppression coil 30, the resonance suppression coil 30 is not involved in resonance between the transmission coil 14 and the reception coil 21, and power transmission from the power transmission device 2 to the power reception device 3 is not affected.

Further, the resonance suppression coil 30 is provided such that a coupling degree between the transmission coil 14 and the resonance suppression coil 30 is higher than a coupling degree between the transmission coil 14 and the reception coil 21 when the transmission coil 14 and the reception coil 21 are electromagnetically coupled. A positional relationship among the transmission coil 14, the reception coil 21, and the resonance suppression coil 30 will be described later in detail.

The switch circuit 31 is connected to both the ends of the resonance suppression coil 30, and switches between short-circuiting or opening the resonance suppression coil 30 in accordance with a control signal from the determination circuit 29. That is, while receiving the control signal for turning on from the determination circuit 29, the switch circuit 31 short-circuits the resonance suppression coil 30. On the other hand, while receiving the control signal for turning off from the determination circuit 29, the switch circuit 31 opens both the ends of the resonance suppression coil 30.

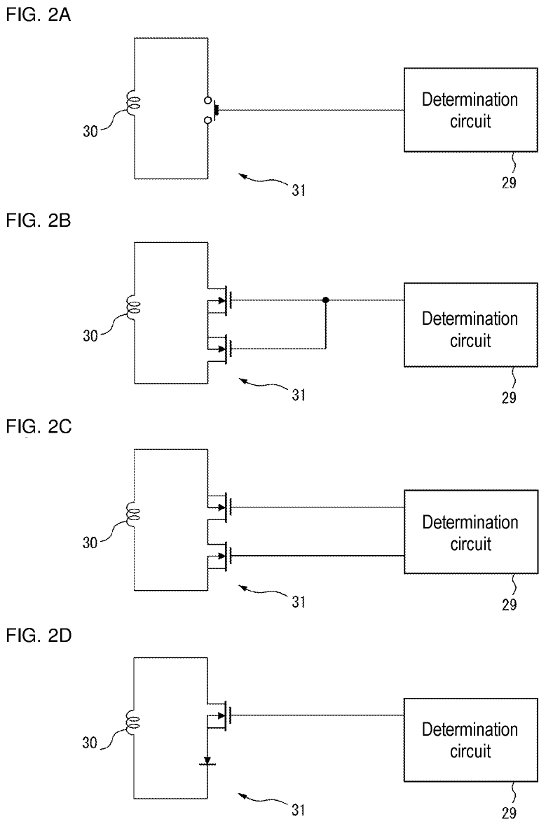

FIGS. 2A to 2D are diagrams each illustrating one example of the switch circuit 31. In an example illustrated in FIG. 2A, the switch circuit 31 has a relay. When the determination circuit 29 turns on the relay, the resonance suppression coil 30 is short-circuited. On the other hand, when the determination circuit 29 turns off the relay, both the ends of the resonance suppression coil 30 are opened.

In an example illustrated in FIG. 2B, the switch circuit 31 has two n-channel MOSFETs connected in series between both the ends of the resonance suppression coil 30. The two MOSFETs are provided such that source terminals are connected to each other and drain terminals are connected to both the ends of the resonance suppression coil 30. Gate terminals of the two MOSFETs are connected to the determination circuit 29. When a relatively high voltage corresponding to the control signal for turning on is applied from the determination circuit 29 to the gate terminals of the two MOSFETs, a current can flow between the source and drain terminals of the MOSFETs, and thus the resonance suppression coil 30 is short-circuited. On the other hand, when a relatively low voltage corresponding to the control signal for turning off is applied from the determination circuit 29 to the gate terminals of the two MOSFETs, the current does not flow between the source and drain terminals of the MOSFETs, and the current does not flow through body diodes of the two MOSFETs because the body diodes are also in opposite directions. Therefore, both the ends of the resonance suppression coil 30 are opened.

In an example illustrated in FIG. 2C, similarly to the example illustrated in FIG. 2B, the switch circuit 31 has two n-channel MOSFETs connected in series between both the ends of the resonance suppression coil 30. However, in the example illustrated in FIG. 2C, the two MOSFETs are provided such that the drain terminals are connected to each other and the source terminals are connected to both the ends of the resonance suppression coil 30. Also in this example, when a relatively high voltage corresponding to the control signal for turning on is applied from the determination circuit 29 to the gate terminals of the two MOSFETs, the resonance suppression coil 30 is short-circuited. On the other hand, when a relatively low voltage corresponding to the control signal for turning off is applied from the determination circuit 29 to the gate terminals of the two MOSFETs, both the ends of the resonance suppression coil 30 are opened.

In an example illustrated in FIG. 2D, the switch circuit 31 has an n-channel MOSFET and a diode connected in series between both the ends of the resonance suppression coil 30. A drain terminal of the MOSFET is connected to one end of the resonance suppression coil 30, and a source terminal is connected to an anode terminal of the diode. A gate terminal of the MOSFET is connected to the determination circuit 29. A cathode terminal of the diode is connected to the other end of the resonance suppression coil 30. Also in this example, when a voltage corresponding to the control signal for turning on is applied from the determination circuit 29 to the gate terminal of the MOSFET, the resonance suppression coil 30 is short-circuited. On the other hand, when a voltage corresponding to the control signal for turning off is applied to the gate terminal of the MOSFET from the determination circuit 29, both the ends of the resonance suppression coil 30 are opened. In this example, even when the MOSFET is turned on, the current flowing from the diode toward the MOSFET is cut off. Therefore, the resonance suppression coil 30 does not affect the resonance of the resonance circuit 20 in half a cycle of the alternating current flowing through the resonance suppression coil 30. However, even in this case, the power transmitted from the power transmission device 2 to the power reception device 3 decreases, and thus the output voltage from the resonance circuit 20 decreases.

When notified that the measured value of the output voltage is equal to or larger than the upper limit threshold value by the determination circuit 29, the communicator 32 generates a wireless signal (output voltage abnormality signal) including abnormal voltage generation information indicating a notification content, and transmits the wireless signal to the communicator 15 of the power transmission device 2. In addition, the communicator 32 generates a wireless signal including determination information indicating whether the non-contact power supply device 1 is performing the constant voltage output operation and whether the measured value of the output voltage is included in the allowable range of the voltage in accordance with the determination result received from the determination circuit 29 in each predetermined transmission cycle from when the measured value of the output voltage becomes equal to or greater than the upper limit threshold value until the constant voltage output operation is resumed. Then, the communicator 32 transmits the wireless signal to the communicator 15 of the power transmission device 2. For this purpose, the communicator 32 includes, for example, a communication circuit that generates a wireless signal in accordance with a predetermined wireless communication standard, and an antenna that outputs the wireless signal. Note that the predetermined wireless communication standard can be, for example, ISO/IEC 15693, ZigBee (registered trademark) or Bluetooth (registered trademark), similarly to the communicator 15.

Hereinafter, the positional relationship among the transmission coil 14, the reception coil 21, and the resonance suppression coil 30 will be described in detail.

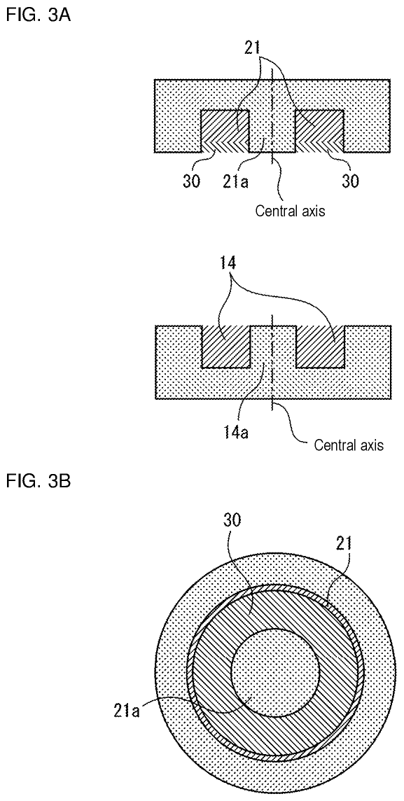

FIG. 3A is a schematic sectional view illustrating an example of the positional relationship among the transmission coil 14, the reception coil 21, and the resonance suppression coil 30 in a plane passing through central axes of the transmission coil 14, the reception coil 21, and the resonance suppression coil 30. FIG. 3B is a schematic plan view illustrating an example of an arrangement of the reception coil 21 and the resonance suppression coil 30 as viewed from the transmission coil 14.

In an example illustrated in FIGS. 3A and 3B, the transmission coil 14 is wound around a magnetic core 14a of a pot core. Similarly, the reception coil 21 and the resonance suppression coil 30 are wound around a magnetic core 21a of the same pot core. In a case where the power transmission device 2 and the power reception device 3 are provided such that power can be transmitted from the power transmission device 2 to the power reception device 3, the reception coil 21 and the resonance suppression coil 30 are provided such that the resonance suppression coil 30 is located on a front side and the reception coil 21 is located on a back side when viewed from the transmission coil 14, that is, the resonance suppression coil 30 is located between the transmission coil 14 and the reception coil 21. As a result, when the power transmission device 2 and the power reception device 3 are provided such that power can be transmitted from the power transmission device 2 to the power reception device 3, the resonance suppression coil 30 is closer to the transmission coil 14 than the reception coil 21, and thus, the coupling degree between the resonance suppression coil 30 and the transmission coil 14 is higher than the coupling degree between the reception coil 21 and the transmission coil 14. Therefore, when the resonance suppression coil 30 is short-circuited, a certain amount of current flows through the resonance suppression coil 30 in accordance with the power applied to the transmission coil 14, and a resonance condition of the resonance circuit 20 including the reception coil 21 changes due to a magnetic field generated by the current. This suppresses an excessive increase in the output power from the resonance circuit 20. Further, by arranging the reception coil 21 and the resonance suppression coil 30 as described above, even when the positional relationship between the power transmission device 2 and the power reception device 3 is changed during power transmission or every time power transmission is performed, the coupling degree between the resonance suppression coil 30 and the transmission coil 14 is kept higher than the coupling degree between the reception coil 21 and the transmission coil 14.

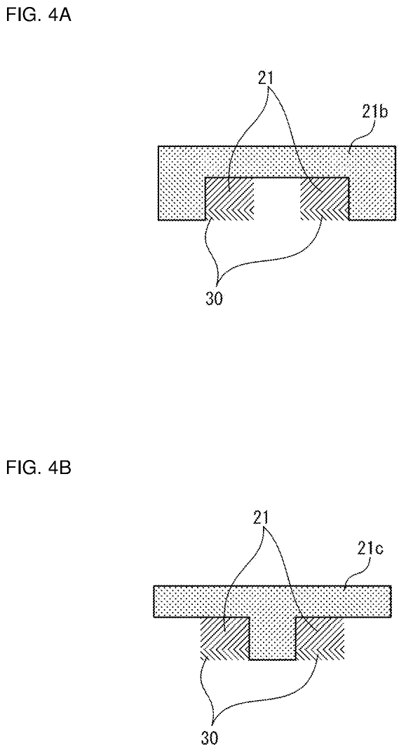

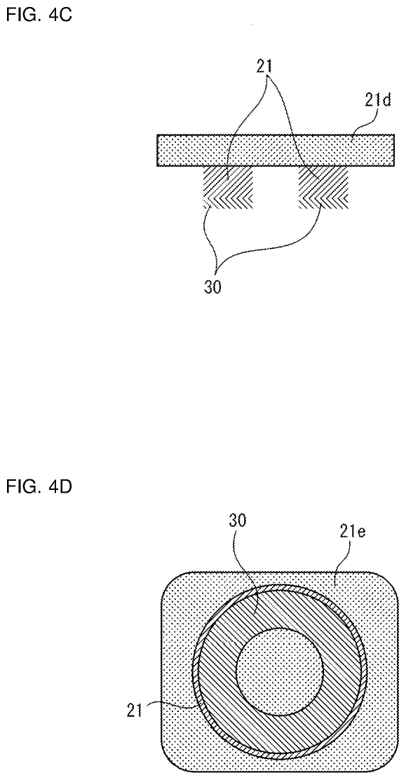

FIGS. 4A to 4C are schematic sectional views illustrating another example of the positional relationship between the reception coil 21 and the resonance suppression coil 30 in a plane passing through the central axes of the reception coil 21 and the resonance suppression coil 30. FIG. 4D is a schematic plan view of another example of the arrangement of the reception coil 21 and the resonance suppression coil 30 as viewed from the transmission coil 14.

In any of examples illustrated in FIGS. 4A to 4C, the reception coil 21 and the resonance suppression coil 30 are wound around the same core. However, in the example illustrated in FIG. 4A, a core 21b is a core of a type that does not have a magnetic core. Further, in the example illustrated in FIG. 4B, a core 21c is a protruding core without a cover that covers the reception coil 21 and the resonance suppression coil 30. Furthermore, in the example illustrated in FIG. 4C, a core 21d is a flat core.

As illustrated in FIG. 4D, the reception coil 21 and the resonance suppression coil 30 may be wound around a core 21e having a substantially rectangular outer shape. The core 21e may be a pot core, or may be a protruding core or a flat core.

Furthermore, in any of the examples illustrated in FIGS. 4A to 4D, similarly to the examples illustrated in FIGS. 3A and 3B, in a case where the power transmission device 2 and the power reception device 3 are provided such that power can be transmitted from the power transmission device 2 to the power reception device 3, the resonance suppression coil 30 is closer to the transmission coil 14 than the reception coil 21. That is, when viewed from the transmission coil 14, the reception coil 21 and the resonance suppression coil 30 are provided such that the resonance suppression coil 30 is located on the front side and the reception coil 21 is located on the back side. Therefore, in these examples, in a case where the power transmission device 2 and the power reception device 3 are provided such that power can be transmitted from the power transmission device 2 to the power reception device 3, the coupling degree between the transmission coil 14 and the resonance suppression coil 30 is also higher than the coupling degree between the transmission coil 14 and the reception coil 21.

Next, a simulation result of the frequency characteristics of the output voltage from the resonance circuit 20 when a magnitude relationship of the coupling degree among the transmission coil 14, the reception coil 21, and the resonance suppression coil 30 is changed will be described.

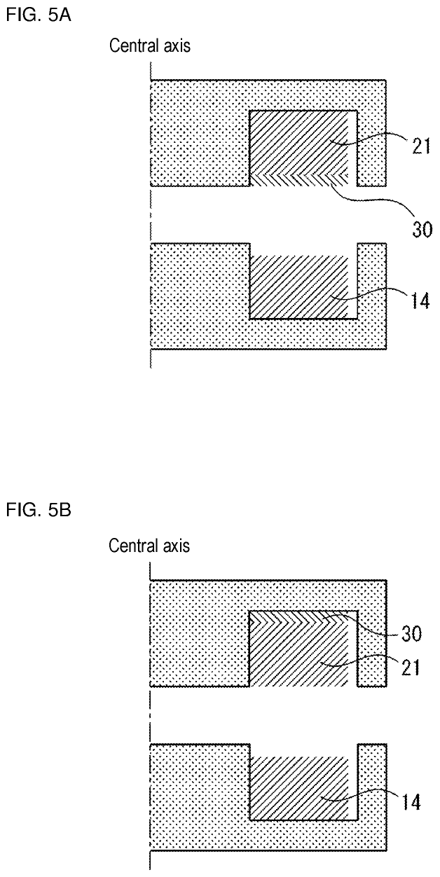

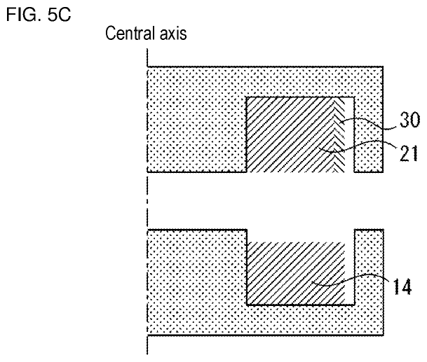

FIG. 5A is a schematic sectional view in a plane passing through the central axes of the transmission coil 14, the reception coil 21, and the resonance suppression coil 30 according to the embodiment. FIGS. 5B and 5C are schematic sectional views in a plane passing through the central axes of the transmission coil 14, the reception coil 21, and the resonance suppression coil 30 according to a comparative example. FIGS. 5A to 5C illustrate a half of the cross section of each coil with the central axes as one end for simplicity.

As illustrated in FIG. 5A, in the embodiment, in a case where the power transmission device 2 and the power reception device 3 are provided such that power can be transmitted from the power transmission device 2 to the power reception device 3, the reception coil 21 and the resonance suppression coil 30 are provided such that resonance suppression coil 30 is closer to the transmission coil 14 than the reception coil 21. On the other hand, in the comparative example illustrated in FIG. 5B, in a case where the power transmission device 2 and the power reception device 3 are provided such that power can be transmitted from the power transmission device 2 to the power reception device 3, the reception coil 21 and the resonance suppression coil 30 are provided such that the reception coil 21 is closer to the transmission coil 14 than the resonance suppression coil 30. Further, in the example illustrated in FIG. 5C, the reception coil 21 and the resonance suppression coil 30 are concentrically wound around the same magnetic core such that the reception coil 21 is on an inner side and the resonance suppression coil 30 is on an outer side.

In this simulation, a relationship between a current I1 flowing to the transmission coil 14, a current I2 flowing to the reception coil 21, a current I3 flowing to the resonance suppression coil 30, and a voltage V1 of the AC power applied to the transmission coil 14 is expressed by the following equation.

$$[ \begin{matrix}V 1 \\ 0 \\ 0\end{matrix} ] = [ \begin{matrix}\frac{1}{j \cdot ω \cdot C 1} + R 1 + j \cdot ω \cdot L 1 & j \cdot ω \cdot M 12 ( {k}_{12} ) & j \cdot ω \cdot M 13 ( {k}_{13} ) \\ j \cdot ω \cdot M 12 ( {k}_{12} ) & R 2 + j \cdot ω \cdot L 2 + \frac{1}{j \cdot ω \cdot C 1} + RL & j \cdot ω \cdot M 23 ( {k}_{23} ) \\ j \cdot ω \cdot M 13 ( {k}_{13} ) & j \cdot ω \cdot M 23 ( {k}_{23} ) & R 3 + Rds + j \cdot ω \cdot L 3\end{matrix} ] \cdot [ \begin{matrix}I 1 \\ I 2 \\ I 3\end{matrix} ] \\ K 12 = M 12 \text{/} {( L {1}^{*} L 2 )}^{1 \text{/} 2} \\ K 13 = M 13 \text{/} {( L {1}^{*} L 3 )}^{1 \text{/} 2} \\ K 23 = M 23 \text{/} {( L {2}^{*} L 3 )}^{1 \text{/} 2} \qquad [ Equation 1 ]$$

Here, k12 is a coupling degree between the transmission coil 14 and the reception coil 21, k13 is a coupling degree between the transmission coil 14 and the resonance suppression coil 30, and k23 is a coupling degree between the reception coil 21 and the resonance suppression coil 30. Further, L1, L2, and L3 are inductances of the transmission coil 14, the reception coil 21, and the resonance suppression coil 30, respectively. Further, C1 is a capacitance of a capacitor connected in series with the transmission coil 14, and R1 is a winding resistance value on the transmission side. In the embodiment, there is no capacitor connected in series with the transmission coil 14. Thus, it is assumed C1=1650 nF such that the resonance frequency of the resonance circuit including the transmission coil 14 and the capacitor is lower than an adjustment range of the frequency of the AC power applied to the transmission coil 14. Further, R2 is a winding resistance value on the reception side, and R3 is a winding resistance value of the resonance suppression coil 30. Then, C2 represents capacitance of the resonance capacitor 22, RL represents a resistance value of the load circuit 26, and Rds represents a resistance value of a closed circuit including the resonance suppression coil 30 when the resonance suppression coil 30 is short-circuited. Further, ω is an angular frequency of the AC power applied to the transmission coil 14, and is represented by ω=2πf using a frequency f of the AC power. An output voltage V2 from the resonance circuit 20 is calculated on the basis of the current I2 and the resistance value RL (that is, V2=RL*I2). In this simulation, the inductance L1 of the transmission coil 14 and the inductance L2 of the reception coil 21 are set to 250 pH, and the inductance L3 of the resonance suppression coil 30 is set to 15 pH. The capacitance C2 of the resonance capacitor 22 is set to 16.5 nF, the winding resistance value R1 on the transmission side and the winding resistance value R2 on the reception side are set to 0.1Ω, and a resistance value (R3+Rds) of the circuit including the resonance suppression coil 30 is set to 0.035Ω. Further, the voltage V1 of the AC power applied to the transmission coil 14 is set to 330 V.

In the embodiment illustrated in FIG. 5A and the comparative examples illustrated in FIGS. 5B and 5C, a diameter and permeability of the magnetic core of the core around which the transmission coil 14 is wound are equal to a diameter and permeability of the magnetic core of the core around which the reception coil 21 and the resonance suppression coil 30 are wound. Further, in the embodiment illustrated in FIG. 5A and the comparative examples illustrated in FIGS. 5B and 5C, the transmission coil 14, the reception coil 21, and the resonance suppression coil 30 are coaxially disposed, and a distance between the transmission coil 14 and the reception coil 21 or the resonance suppression coil 30 which is disposed closer to the transmission coil 14 is equal.

In the embodiment illustrated in FIG. 5A, the coupling degree K13 between the transmission coil 14 and the resonance suppression coil 30 is larger than the coupling degree K12 between the transmission coil 14 and the reception coil 21. In this simulation, the coupling degree K12 between the transmission coil 14 and the reception coil 21 is 0.504, the coupling degree K13 between the transmission coil 14 and the resonance suppression coil 30 is 0.583, and the coupling degree K23 between the reception coil 21 and the resonance suppression coil 30 is 0.882. In the comparative example illustrated in FIG. 5B, the coupling degree K13 between the transmission coil 14 and the resonance suppression coil 30 is smaller than the coupling degree K12 between the transmission coil 14 and the reception coil 21. Therefore, in this simulation, the coupling degree K12 between the transmission coil 14 and the reception coil 21 is 0.532, the coupling degree K13 between the transmission coil 14 and the resonance suppression coil 30 is 0.440, and the coupling degree K23 between the reception coil 21 and the resonance suppression coil 30 is 0.914. Furthermore, in the comparative example illustrated in FIG. 5C, a surface of the reception coil 21 facing the transmission coil 14 is larger than a surface of the resonance suppression coil 30 facing the transmission coil 14. Thus, the coupling degree K13 between the transmission coil 14 and the resonance suppression coil 30 is smaller than the coupling degree K12 between the transmission coil 14 and the reception coil 21. Therefore, in this simulation, the coupling degree K12 between the transmission coil 14 and the reception coil 21 is 0.520, the coupling degree K13 between the transmission coil 14 and the resonance suppression coil 30 is 0.466, and the coupling degree K23 between the reception coil 21 and the resonance suppression coil 30 is 0.846.

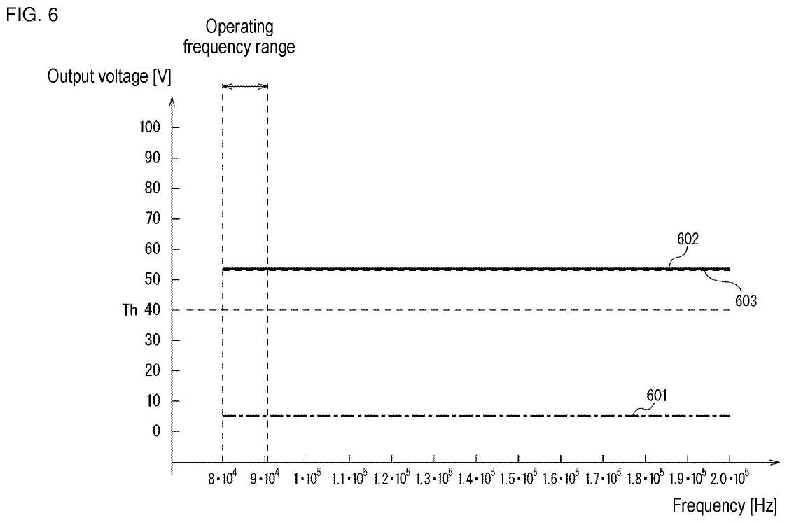

FIG. 6 is a diagram illustrating an example of a simulation result of the frequency characteristics of the output voltage when the resistance value RL of the load circuit 26 connected to the power reception device 3 is 1 kΩ, that is, when the load connected to the power reception device 3 is small (that is, the current flowing through the load circuit 26 is small). In FIG. 6, a horizontal axis represents the frequency, and a vertical axis represents the output voltage. A graph 601 represents the frequency characteristics of the output voltage when the resonance suppression coil 30 is short-circuited in the arrangement of the reception coil 21 and the resonance suppression coil 30 according to the embodiment illustrated in FIG. 5A. A graph 602 represents the frequency characteristics of the output voltage when the resonance suppression coil 30 is short-circuited in the arrangement of the reception coil 21 and the resonance suppression coil 30 according to the comparative example in FIG. 5B. A graph 603 represents the frequency characteristics of the output voltage when the resonance suppression coil 30 is short-circuited in the arrangement of the reception coil 21 and the resonance suppression coil 30 according to the comparative example illustrated in FIG. 5C. As illustrated in the graph 601, in the embodiment, even when the resistance value Ro of the load circuit 26 is 1 kΩ, the output voltage is suppressed to be sufficiently lower than a level Th determined to be overvoltage. On the other hand, as shown in the graphs 602 and 603, in the comparative example, the output voltage is substantially equal to or higher than the level Th at which the overvoltage is determined, and it can be seen that the suppression of the output voltage is not sufficient. Note that, in a case where the resonance suppression coil 30 is opened, in both the embodiment and the two comparative examples, the output voltage is much higher than the level Th determined to be overvoltage over the entire adjustment range of the frequency of the AC power supplied to the transmission coil 14 when the non-contact power supply device is performing the constant voltage output operation, that is, over an entire operating frequency range.

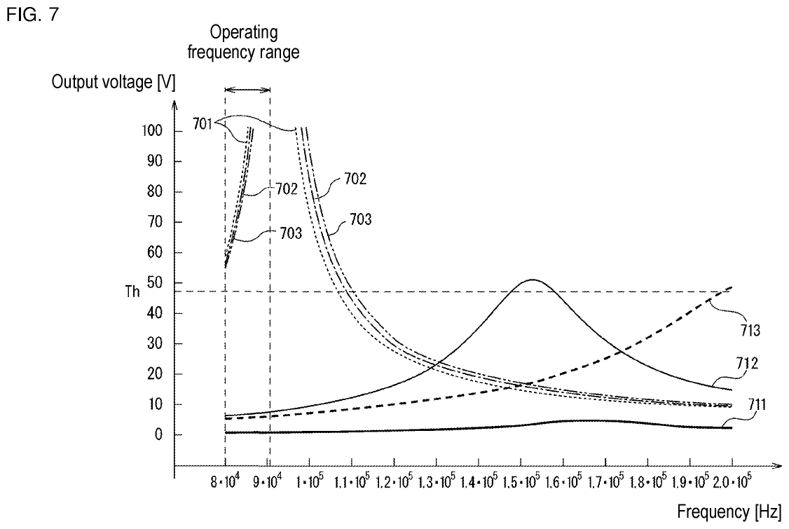

FIG. 7 is a diagram illustrating an example of a simulation result of the frequency characteristics of the output voltage in a case where there is a load connected to the power reception device 3. In FIG. 7, the horizontal axis represents the frequency, and the vertical axis represents the output voltage. A graph 701 represents the frequency characteristics of the output voltage when the resonance suppression coil 30 is opened in the arrangement of the reception coil 21 and the resonance suppression coil 30 according to the embodiment illustrated in FIG. 5A. A graph 702 represents the frequency characteristics of the output voltage when the resonance suppression coil 30 is opened in the arrangement of the reception coil 21 and the resonance suppression coil 30 according to the comparative example in FIG. 5B. Further, a graph 703 represents the frequency characteristics of the output voltage when the resonance suppression coil 30 is opened in the arrangement of the reception coil 21 and the resonance suppression coil 30 according to the comparative example illustrated in FIG. 5C. Further, a graph 711 represents the frequency characteristics of the output voltage when the resonance suppression coil 30 is short-circuited in the arrangement of the reception coil 21 and the resonance suppression coil 30 according to the embodiment illustrated in FIG. 5A. A graph 712 represents the frequency characteristics of the output voltage when the resonance suppression coil 30 is short-circuited in the arrangement of the reception coil 21 and the resonance suppression coil 30 according to the comparative example in FIG. 5B. A graph 713 represents the frequency characteristics of the output voltage when the resonance suppression coil 30 is short-circuited in the arrangement of the reception coil 21 and the resonance suppression coil 30 according to the comparative example illustrated in FIG. 5C. In this simulation, the resistance value RL of the load circuit 26 is set to 10Ω. Further, the adjustment range of the frequency of the AC power supplied to the transmission coil 14 when the non-contact power supply device is performing the constant voltage output operation, that is, the operating frequency range is in a range of 8×10⁴ Hz to 9×10⁴ Hz inclusive.

In this simulation, regardless of the positional relationship between the reception coil 21 and the resonance suppression coil 30, when the resonance suppression coil 30 is opened, the coupling degree between the transmission coil 14 and the reception coil 21 is significantly high. Thus, the output voltage is significantly higher than the level Th at which the output voltage is determined to be overvoltage within the operating frequency range. On the other hand, when the resonance suppression coil 30 is short-circuited, in both the embodiment and the two comparative examples, the resonance condition of the resonance circuit 20 changes due to the current flowing through the resonance suppression coil 30. Thus, the output voltage is sufficiently lower than the level Th at which the output voltage is determined to be overvoltage within the operating frequency range.

As described above, in a case where the coupling degree between the transmission coil 14 and the reception coil 21 is higher than the coupling degree between the transmission coil 14 and the resonance suppression coil 30, protection against overvoltage by the resonance suppression coil 30 sufficiently functions only when a load is connected to the power reception device 3. On the other hand, when the coupling degree between the transmission coil 14 and the resonance suppression coil 30 is higher than the coupling degree between the transmission coil 14 and the reception coil 21 as in the embodiment, it can be seen that protection against overvoltage sufficiently functions regardless of presence or absence of a load connected to the power reception device 3.

Hereinafter, the operation of the non-contact power supply device 1 will be described in detail.

In the embodiment, upon receipt of abnormal voltage generation information from the communicator 15, the control circuit 17 of the power transmission device 2 starts adjustment of the switching frequency and the voltage of the AC power supplied to the transmission coil 14 such that the non-contact power supply device 1 can perform the constant voltage output operation. On the basis of the determination information received from the communicator 15, the control circuit 17 adjusts the switching frequency and the voltage of the AC power supplied from the power supply circuit 10 to the transmission coil 14 until the non-contact power supply device 1 restarts the constant voltage output operation.

As described above, the non-contact power supply device according to the embodiment does not use resonance on the transmission side, but has a configuration similar to a configuration of a so-called SS system. Thus, the frequency characteristics of the output voltage of the non-contact power supply device 1 is similar to the frequency characteristics of the output voltage of the non-contact power supply device having the SS system. Therefore, even if either the resistance value of the load circuit 26 or the coupling degree between the transmission coil 14 and the reception coil 21 changes, the output voltage is kept substantially constant by appropriately adjusting the switching frequency and the voltage of the AC power applied to the transmission coil 14.

Then, in order to achieve the constant voltage output operation, the control circuit 17 controls the switching frequency and the voltage of the AC power applied to the transmission coil 14 as follows.

Upon receipt of the abnormal voltage generation information from the communicator 15, the control circuit 17 reduces the voltage of the AC power applied to the transmission coil 14 to a lower limit of voltage. As a result, in the power reception device 3, even when the resonance suppression coil 30 is opened, the output voltage from the resonance circuit 20 decreases to be equal to or less than the upper limit threshold value. Thereafter, in a case where the determination information included in the wireless signal received from the power reception device 3 via the communicator 15 indicates that the non-contact power supply device 1 is not performing the constant voltage output operation, the control circuit 17 changes the switching frequency of the AC power within a predetermined frequency region (that is, within the operating frequency range). For example, the predetermined frequency region can be a frequency region in which a frequency at which a constant voltage output is obtained at a minimum value of an assumed coupling degree between the transmission coil 14 and the reception coil 21 is a lower limit and a frequency at which a constant voltage output is obtained at a maximum value of an assumed coupling degree between the transmission coil 14 and the reception coil 21 is an upper limit in a case where power is supplied from the power transmission device 2 to the power reception device 3.

When changing the switching frequency, the control circuit 17 may increase the switching frequency in order from the lower limit to the upper limit of the predetermined frequency region, or conversely, may decrease the switching frequency in order from the upper limit to the lower limit of the predetermined frequency region. At that time, the control circuit 17 preferably changes the switching frequency in a stepwise manner so as to maintain the same switching frequency for a period longer than a cycle in which the determination circuit 29 switches on and off the switching element 28 such that the determination circuit 29 of the power reception device 3 can check whether the output voltage becomes substantially constant.

When the determination information included in the wireless signal received from the power reception device 3 via the communicator 15 indicates that the measured value of the output voltage is not included in the allowable range of the voltage but becomes substantially constant even when a resistance of the load circuit 26 changes, that is, the constant voltage output operation is performed, the control circuit 17 keeps the switching frequency constant thereafter. Next, the control circuit 17 determines the duty ratio with reference to a reference table indicating a relationship between the switching frequency and the duty ratio of the on-off control of the switching element SW of the power factor correction circuit 12, the duty ratio being a constant voltage output regardless of the coupling degree at the switching frequency. Then, the control circuit 17 controls the gate driver 16-1 to switch on and off the switching element SW of the power factor correction circuit 12 in accordance with the duty ratio. As a result, the voltage applied to the transmission coil 14 is adjusted such that the output voltage from the resonance circuit 20 is included in the allowable range of the voltage, that is, a constant voltage is outputted regardless of the coupling degree. Then, when the determination information included in the wireless signal received from the power reception device 3 via the communicator 15 indicates that the measured value of the output voltage is included in the allowable range of the voltage, the control circuit 17 keeps the switching frequency and the voltage of the AC power supplied to the transmission coil 14 constant.

Instead of determining the duty ratio with reference to the reference table, the control circuit 17 may gradually change the duty ratio until the determination information included in the wireless signal received from the power reception device 3 via the communicator 15 indicates that the measured value of the output voltage is included in the allowable range of the voltage.

Further, in order to improve energy transmission efficiency, the power supply circuit 10 and the transmission coil 14 of the power transmission device 2 preferably perform a soft switching (inductive) operation continuously. In order for the power supply circuit 10 and the transmission coil 14 to perform the soft switching operation, a phase of the current flowing through the transmission coil 14 is preferably delayed from a phase of the applied voltage. As a result, for example, when the switching element 13-1 and the switching element 13-4 are turned on, a current flows from the source terminal to the drain terminal of the switching element 13-1, and thus the power supply circuit 10 and the transmission coil 14 perform the soft switching operation. This suppresses occurrence of a switching loss.

As described above, in the non-contact power supply device, the power reception device is provided with the resonance suppression coil for changing the resonance condition of the resonance circuit. The reception coil and the resonance suppression coil are disposed such that the coupling degree between the transmission coil and the resonance suppression coil is higher than the coupling degree between the transmission coil and the reception coil of the power transmission device. Then, when the output voltage from the resonance circuit of the power reception device becomes higher than the upper limit threshold value, the non-contact power supply device changes the resonance frequency of the resonance circuit by short-circuiting the resonance suppression coil that can be electromagnetically coupled to the reception coil of the resonance circuit to reduce the power transmitted. Therefore, even in a case where the load circuit is not connected to the power reception device or the current flowing through the load circuit connected to the power reception device is significantly small, the non-contact power supply device can prevent the power reception device or the load circuit from failing due to an excessive rise in the output voltage from the resonance circuit.

The positional relationship between the reception coil 21 and the resonance suppression coil 30 is not limited to the above embodiment.

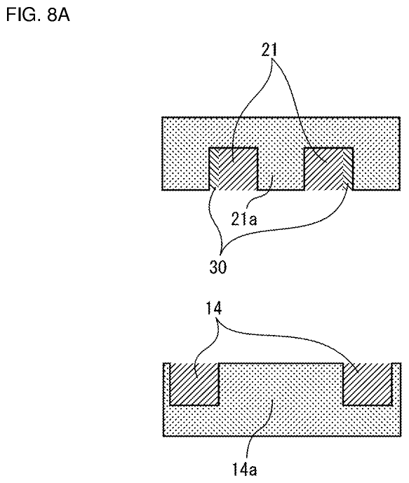

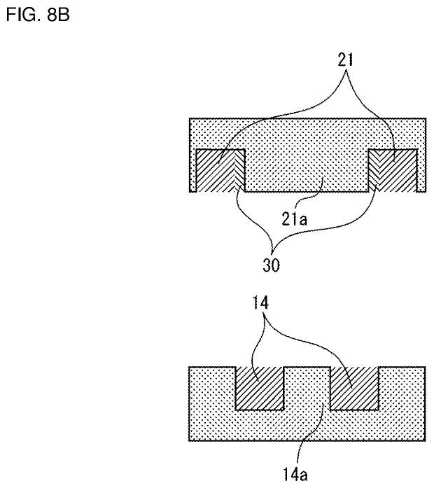

FIGS. 8A and 8B are schematic sectional views each illustrating the positional relationship between the reception coil 21 and the resonance suppression coil 30 in a plane passing through the center axes of the reception coil 21 and the resonance suppression coil 30 according to a modification. In an example illustrated in FIG. 8A, similarly to the comparative example illustrated in FIG. 5C, the reception coil 21 and the resonance suppression coil 30 are concentrically wound around the same magnetic core 21a such that the reception coil 21 is on the inner side and the resonance suppression coil 30 is on the outer side. However, in this example, the diameter of the magnetic core 14a around which the transmission coil 14 is wound is larger than the diameter of the magnetic core 21a around which the reception coil 21 and the resonance suppression coil 30 are wound, and the diameter of the magnetic core 14a is substantially equal to or larger than the diameter of the reception coil 21. Therefore, when the transmission coil 14, the reception coil 21, and the resonance suppression coil 30 are disposed such that the central axis of the transmission coil 14 is identical to the central axis of the reception coil 21, the resonance suppression coil 30 is closer to the transmission coil 14 than the reception coil 21. As a result, the coupling degree between the transmission coil 14 and the resonance suppression coil 30 is larger than the coupling degree between the transmission coil 14 and the reception coil 21.

In an example illustrated in FIG. 8B, contrary to the example illustrated in FIG. 8A, the reception coil 21 and the resonance suppression coil 30 are concentrically wound around the same magnetic core 21a such that the reception coil 21 is on the outer side and the resonance suppression coil 30 is on the inner side. In this example, the diameter of the magnetic core 21a around which the reception coil 21 and the resonance suppression coil 30 are wound is substantially equal to or smaller than a diameter of the resonance suppression coil 30. Therefore, when the transmission coil 14, the reception coil 21, and the resonance suppression coil 30 are provided such that the central axis of the transmission coil 14 is identical to the central axis of the reception coil 21, the resonance suppression coil 30 is closer to the transmission coil 14 than the reception coil 21. As a result, the coupling degree between the transmission coil 14 and the resonance suppression coil 30 is larger than the coupling degree between the transmission coil 14 and the reception coil 21.

As described above, in any of the modifications illustrated in FIGS. 8A and 8B, the coupling degree between the transmission coil 14 and the resonance suppression coil 30 is larger than the coupling degree between the transmission coil 14 and the reception coil 21. Therefore, similarly to the embodiment, even in a case where the load circuit is not connected to the power reception device or the current flowing through the load circuit connected to the power reception device is significantly small, the non-contact power supply device can prevent the power reception device or the load circuit from failing due to an excessive rise in the output voltage from the resonance circuit.

In another modification, in the power transmission device 2, the power supply circuit that supplies the AC power to the transmission coil 14 may have a circuit configuration different from a circuit configuration of the embodiment as long as the circuit can variably adjust the switching frequency and the voltage applied to the transmission coil 14. For example, the power supply circuit may have a half-bridge type inverter circuit instead of the full-bridge type inverter circuit in the above embodiment.

In the embodiment and the modifications, a capacitor connected in series with the transmission coil 14 (hereinafter, for convenience of description, the capacitor is referred to as a series capacitor) may be provided in order to cut off a direct current. However, also in this case, the transmission coil 14 and the series capacitor preferably do not operate as a resonance circuit in the frequency range in which the switching frequency is adjusted. For that purpose, the capacitance of the series capacitor is preferably set such that the resonance frequency of the transmission coil 14 and the resonance frequency of the series capacitor are smaller than a lower limit frequency of the frequency range in which the resonance frequency and the switching frequency of the resonance circuit 20 of the power reception device 3 are adjusted. Thus, even in a case where the resonance suppression coil 30 is short-circuited and the resonance of the resonance circuit 20 is suppressed, the resonance on the transmission side is not used, and therefore, the input impedance becomes a large value to some extent, and the current flowing through transmission coil 14 becomes small. As a result, the energy loss is suppressed.

In still another modification, a series capacitor connected in series with the transmission coil 14 may be provided such that the non-contact power supply device operates in accordance with the so-called SS system in the embodiment and the modifications described above. In this case, the capacitance of the series capacitor is preferably set such that the resonance frequency of the transmission coil 14 and the series capacitor is substantially equal to the resonance frequency of the resonance circuit 20 of the power reception device 3 for the transmission coil 14 and the series capacitor to operate as a resonance circuit in the frequency range in which the switching frequency is adjusted.

In still another modification, the determination circuit 29 may have a timer circuit. In this case, the determination circuit 29 may measure elapsed time after the resonance suppression coil 30 is short-circuited by the timer circuit, control the switch circuit 31 so as to open both the ends of the resonance suppression coil 30 at a point of time when a predetermined period required for the control circuit 17 of the power transmission device 2 to lower a voltage of the AC power applied to the transmission coil 14 elapses, and start the on-off control of the switching element 28. Alternatively, the communicator 15 of the power transmission device 2 and the communicator 32 of the power reception device 3 may be configured to be able to communicate bidirectionally. In this case, when the control circuit 17 of the power transmission device 2 lowers the voltage of the AC power applied to the transmission coil 14, the control circuit 17 may notify the communicator 32 of the power reception device 3 via the communicator 15 that the voltage has been lowered. When the determination circuit 29 of the power reception device 3 is notified via the communicator 32 that the voltage of the AC power applied to the transmission coil 14 has been lowered, the determination circuit may control the switch circuit 31 to open both the ends of the resonance suppression coil 30 and may start the on-off control of the switching element 28.

Also in this modification, the non-contact power supply device can prevent the power reception device or the load circuit from failing due to an excessive rise in the output voltage from the resonance circuit, and can suppress an energy loss by enabling continuous power transmission.

In still another modification, the switching element 28 connected between the load circuit 26 and the rectifying and smoothing circuit 23 may be omitted. In this case, upon receipt of the abnormal voltage generation information via the communicator 15, the control circuit 17 of the power transmission device 2 only has to lower the voltage of the AC power applied to the transmission coil 14 until the output voltage from the resonance circuit 20 becomes less than the upper limit threshold value. Furthermore, in this case, the power supply circuit of the power transmission device 2 can be any of various circuits capable of adjusting the voltage of the AC power applied to the transmission coil 14.

Further, in the embodiment and the modifications, in a case where the communicator of the power transmission device and the communicator of the power reception device can be connected to each other by wire, each of the communicators only has to have a communication circuit capable of communicating a signal including determination information and the like by wire.

In this way, those skilled in the art can make various modifications in accordance with the embodiment within the scope of the invention.

### DESCRIPTION OF SYMBOLS

1 non-contact power supply device
2 power transmission device
10,110 power supply circuit
11 power source
12 power factor correction circuit
13-1˜13-4 switching element
14 transmission coil
14a magnetic core
15 communicator
16-1,16-2 gate driver
17 control circuit
3 power reception device
20 resonance circuit
21 reception coil
21a magnetic core
21b˜21e core
22 resonance capacitor
23 rectifying and smoothing circuit
24 full-wave rectifier circuit
25 smoothing capacitor
26 load circuit
27 voltage detection circuit
28 switching element
29 determination circuit
30 resonance suppression coil
31 switch circuit
32 communicator

1. A non-contact power supply device comprising:
a power transmission device; and
a power reception device to which power is transmitted from the power transmission device in a non-contact manner, wherein
the power transmission device comprises
a transmission coil configured to supply power to the power reception device, and
a power supply circuit configured to supply AC power to the transmission coil,
the power reception device comprises
a resonance circuit comprising a reception coil configured to receive power from the power transmission device and a resonance capacitor connected in series with the reception coil,
a rectifier circuit configured to rectify power received via the resonance circuit,
a resonance suppression coil provided to be electromagnetically couplable with the reception coil,
a switch circuit connected to the resonance suppression coil and configured to switch between short-circuiting and opening of the resonance suppression coil,
a voltage detection circuit configured to measure an output voltage of power outputted from the rectifier circuit and obtain a measured value of the output voltage, and
a determination circuit configured to control the switch circuit to short-circuit the resonance suppression coil in response to the measured value of the output voltage becoming equal to or larger than a predetermined upper limit threshold value, wherein
the power transmission device and the power reception device are provided such that power is transmitted from the transmission coil to the reception coil, and the reception coil and the resonance suppression coil are provided such that a coupling degree between the resonance suppression coil and the transmission coil is higher than a coupling degree between the reception coil and the transmission coil.

2. The non-contact power supply device according to claim 1, wherein, the power transmission device and the power reception device are provided such that power is transmitted from the transmission coil to the reception coil, and the reception coil and the resonance suppression coil are provided such that the resonance suppression coil is closer to the transmission coil than the reception coil.

3. The non-contact power supply device according to claim 2, wherein the power transmission device and the power reception device are provided such that power is transmitted from the transmission coil to the reception coil, and the reception coil and the resonance suppression coil are provided such that the resonance suppression coil is located between the transmission coil and the reception coil.
